(19) United States
(12) Patent Application Publication
(10) Pub. No.: US 2010/0017862 A1
(43) Pub. Date: Jan. 21, 2010

(54) METHOD AND RELATED SYSTEM FOR AUTHENTICATING E-LEARNING STUDY

(76) Inventors: Jong Hae Kim, Seoul (KR); Kyoung Ja Han, Seoul (KR); Michael Jitae Kim, Glendale, CA (US)

Correspondence Address: BROOKS KUSHMAN P.C., 1000 TOWN CENTER, TWENTY-SECOND FLOOR, SOUTHFIELD, MI, 48075, US

(21) Appl. No.: 12/443,056

(22) PCT Filed: Sep. 27, 2007
(86) PCT No.: PCT/KR07/04701

§ 371 Date: Mar. 26, 2009

(30) Foreign Application Priority Data
Sep. 27, 2006 (KR) 10 2006 0094074

(51) Int. Cl. G06F 21/22; H04L 29/06; G06F 7/04; G06F 15/16; G06F 3/00

(52) U.S. Cl. 726/7; 709/237; 704/8; 715/717

(57) ABSTRACT

This invention provides an e-learning system having a capability for authenticating the learner's ID via Internet with the learner's physical Bio-ID such as a fingerprint, an iris and/or a vein of the learner into the login process and additional periodic checking according to the instruction signal generated by the contents. Accordingly, once a learner successfully logs into his or her account, the computer will monitor each learner's progress on a lecture or an examination. Thus, the invention enable to operate a full online distance education from a single database for the worldwide learners, at each learner's own space and scheduling, anytime, anyplace, in any of the major languages selected by the learners and accurately account credit hours of each learner by the lectures and examination on demand for conferring a degree or to transfer the credit to the university where they will earn their degrees.

### CROSS REFERENCE TO RELATED APPLICATION

This invention is a continuation-in-part of PCT/KR2002/000138 (Priority Feb. 8, 2001) and GB 2393013 filed on Jan. 31, 2002.

### TECHNICAL FIELD

This invention relates to the method of e-learning study, testing and authentication of the e-learning system, in which the host-computer performs authentication procedure according to Biometric Identification (Bio-ID) of each learner at e-learning study at the login process and additional periodic checking for ensuring students' attendance or examination by authenticating the student's physical identity via Internet enable to determine the true attendance of the e-learning class or an examination for granting credits or the qualification.

### BACKGROUND OF THE INVENTION

In the existing e-learning system, the e-learning host-computer checked the attendance of learners by simply checking ID and Password. However, this method had a serious loophole for determining the true attendance of class or examination even when a proxy sits in the online lecture or examination on behalf of the registrant.

In order to resolve the said issue, a system where the host-computer authenticates the true attendance by scanning the fingerprint image of the students was developed. However, the said system had a serious loophole that cannot distinguish the true attendance of the e-learning class when learners quit seat after login process until logout, and do not study every stage according to the chapter of lectures.

The most significant technical problem existing in the distance education system's is in ensuring students' attendance. Unlike on-campus education, it is almost impossible for e-learning systems to ascertain the students' physical identity via the Internet. Thus, e-learning systems still require on-site examinations to give proper credit, and the full online international distance education was not realized.

The 21st century is the time of transition where the existing offline campus university education system rapidly shifts to e-learning system lead by the evolution of the Internet and IT technologies. In addition, most of universities in the world allow students to acquire 50 percent of credits for graduation through e-learning. It enables students to shop their courses at e-learning institutions and transfer the credits to the university where they will earn their degrees.

However, there is no online e-learning system that allows online examination to be taken per each lecture for acquiring credits due to the lack of technique of identifying the physical identity via Internet. Therefore, it is impossible to establish the International Credit Mall where the worldwide students are shopping their courses from a pool of lectures or professors.

### DETAILED EXPLANATION OF THE INVENTION

<Technical Context>

This invention relates to the e-learning technology that allows Global Remote Education Service to be provided to worldwide learners by utilizing the integrated e-learning system that authenticates the registrant's ID through the Internet by using the Bio-ID of each learner per curricular and examination advancement, for granting online credits with e-learning database of multilingual contents.

<Technical Solutions>

This invention provides the technology for checking the true class attendance of the learner during online lecture and/or examination by using multiple authentication procedures that involves the procedure of registering the registrant's Bio-ID, such as a fingerprint, an iris of eye or a veins, or etc., to the e-learning host-computer, having a means for generating signals requesting to input the registrant's Bio-ID to the each stage of contents of the e-learning examination and/or the lecture, and the procedure of the host-computer monitoring and recording the accumulation of hours for honoring credits once a student successfully lose into his or per account.

Also the invention provides the technology for operating a global credit shopping mall with lectures' pool of worldwide prominent professors, that allows the students 5 to study and examine via Internet and having the means of Internet communication such as a blog or a homepage of each lecture, etc., allowing students to communicate between a professor and a plurality of learner as well as each other and issuing certificate of each credit of lecture when the students successfully studied and passed examination with their physical Bio-ID.

[Advantageous Effects]

This invention provides to an online e-learning system that the host-computer performs authentication of the learner's Bio-ID per curricular advancement so that the true attendance of the registrant can be more accurately determined in online than the offline campus. Therefore it provides the technology to give a credit for class attendance just like the offline campus, even by the e-learning study via online.

Also, as the host-computer checks and authenticates the Bio-ID of each learner during the online study and examination, this invention provides technology to solve the problems of the inconvenience of offline examination in the existing remote education.

Furthermore, the system developed by this invention checks and authenticates Bio-ID of each learner based on the individual curricular advancement, even when the learners choose to take a certain part of session of the entire lecture, the host-computer will accumulate and combine sessions taken by the learners together. Thus, this invention allows learners to study partially to meet schedule and to be free from limitations such as time and space in studying

Also, this invention provides an e-learning system that maximizes the learning effect since the students concentrate during the lecture class by studying the lecture partially whenever they can concentrate.

Also, as the invention comprises DB containing multilingual dubbed lecture contents, the language is no longer a barrier since learners will be able to choose the language of the lecture from the database. Therefore, this invention provides the method to study the top class lectures of the worldwide prominent professors without going abroad with their mother language.

Furthermore, this invention provides technology how to create the online credit shopping mall where student of all over the world can study, take examination and acquire credits in the cyberspace.

Another advantage of this invention is that the quality and service of the lectures are the top since the income of professors are increased by the number of registrants registered and due to the competition among professors in the pool. Thus, this provides the best solution for the students who rally want quality education.

Accordingly, this invention solves the problem existing on the offline campus education system that the students must attend the class even they are sick or annoying to the serous traffic congestion. Students can be free from limitation such as time, space, language and nationality. Students can study even they have full-time job or the military service. It provides a fully online global ubiquitous education system.

### BRIEF DESCRIPTION OF THE DRAWING

The brief explanations of drawings are as follows.

FIG. 1 is the flow chart of the education system of this invention.

FIG. 2 is the flow chart of the remote examination system of this invention.

FIG. 3 is the operation illustration chart of the e-learning system of this invention.

### DETAILED DESCRIPTION OF THE PREFERRED EMBODIMENTS

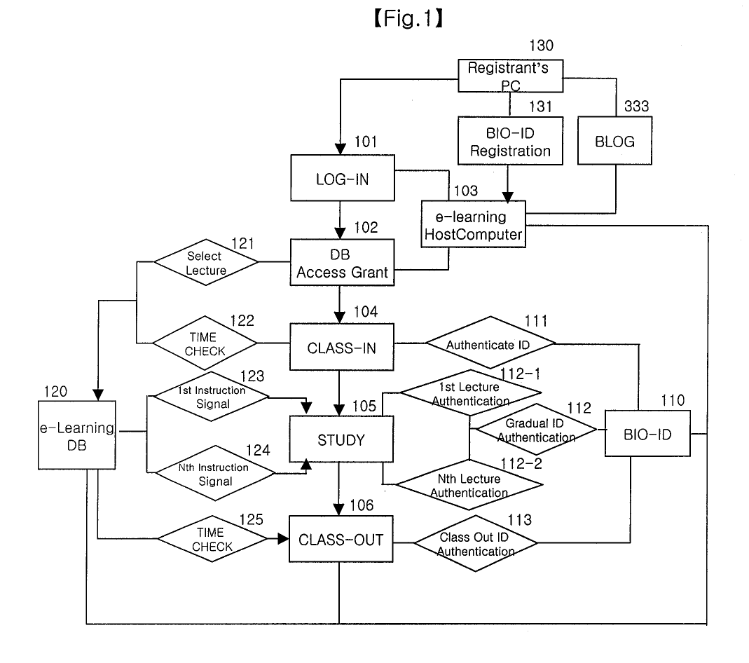

To overcome the limitation in the prior art described above, based on understanding and predicting current situation and certain limitation that will occur in the future. Referring to following attached FIG. 1. 2. 3. It explains a constitution of this invention, authentication method and effect accordingly for achieving above stated aims.

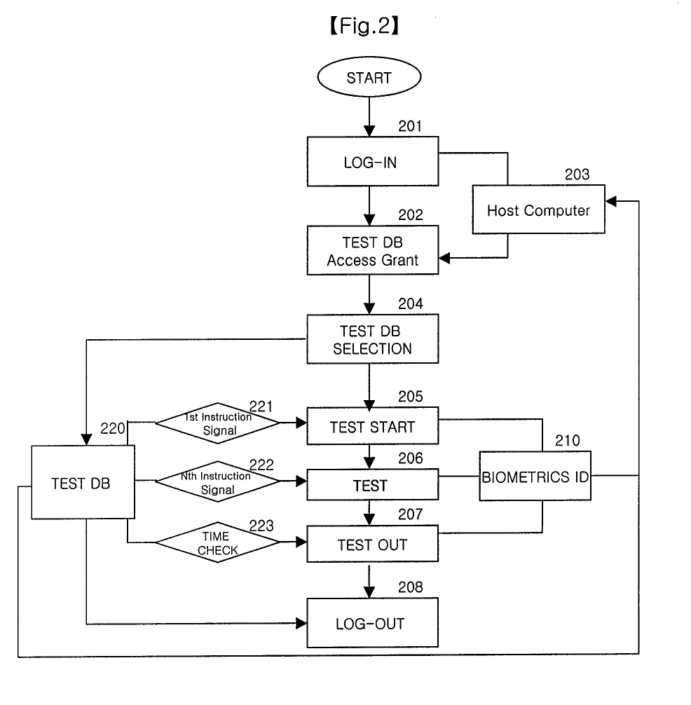

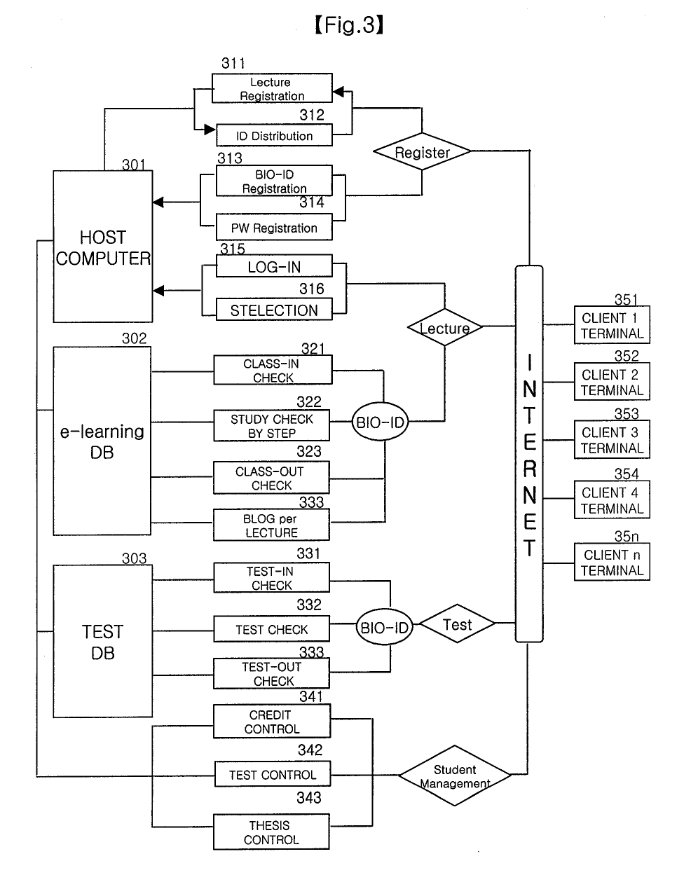

FIG. 1 is the flow chart about education system of this invention, FIG. 2 is the flow chart about the remote examination system of this invention, and FIG. 3 is the operation illustration chart of the e-learning system.

Referring to FIG. 3, this invention of e-learning system is comprising, a DB (Database) 302 of digital video on demand contents of lectures having a means for 5 generating an instruction signal requesting learners to input their Bio-ID (Biometric Identification) when login, logout and at least one or more parts of the each lecture, a TEST DB 303 of question pool of each lecture for EOD (Examination On-Demand) having a means for generating on instruction signal requesting learners to input their Bio-ID at every question or at random of the questions, a communication means 333 such as a blog or a homepage for communicating between a professor and a plurality of learners, and a host-computer 301 for controlling the system by authenticating the Bio-ID of learners at login, logout and at least one or more during the studying or testing process and calculating the accumulation of the each partial study of the lecture for granting credit.

Referring to FIG. 2 and FIG. 3, the method for authenticating the learner's ID in a e-learning system having an e-learning host-computer 301, a DB 302 of e-learning contents and a plurality of the learner's PC terminal 351˜35n, the method is comprising, a step for registering learner's Bio-ID such as a fingerprint, an iris of eye, a veins or etc., to the e-learning host-computer 301, a step for organizing a DB 302 of contents of e-learning lectures DVOD (Digital Video On Demand) and each e-learning lecture having a means for generating an instruction signal requesting the learners to input their Bio-ID according to the progress of each lecture, a step for authenticating the learner's Bio-ID to determine the login time of the lecture, according to the instruction signal generated by the contents of each lecture, a step for authenticating the learner's Bio-ID by the host-computer according to the instruction signal gradually generated during the progress of each lecture, and a step for authenticating the learner's Bio-ID for determining the logout time of each lecture.

Wherein the ID authenticating step during lecture class, this system also applicable the instruction signal to be generated by the host-computer 301 with its' software programmed, or combining the signal generated by the host-computer and the contents of each lecture.

Wherein the ID authenticating step during lecture class, when the learners fail to input their Bio-ID, the host-computer controls stopping the progress of lecture and generating a warning signal to the learner's terminal 351˜35n.

This system is further comprising the step for determining the class in and out time of each lecture class by inputting the learner's Bio-ID signal so that the host-computer memorizes class in and out time with contents of each lecture of logout point and calculate the accumulation of learning hours for the partial study.

When the learners what to attend a lecture partially, not attend the entire lecture, the learner would input Bio-ID when closing the lecture. Then host-computer record and save the closing time and the parts lectures by the learner's ID.

When the learners attend the lecture later, the learners would input their Bio-ID. Then the host-computer 301 recognizes the last section of lectures that the learners logout, and monitoring continuously thereinafter and accumulate the studying data.

By this function, the learner's can maximize the learning effect. They can study at the best time of biorhythm when they can concentrate on studying. It enables to solve the conventional education system that the students must attend at class even though their physical or mental condition is inconvenient sick.

When constructing the e-learning DB, the contents of lecture are dubbed into multilingual to choose language which they prefers and make a system for learners the language is no longer a barrier since learners will be able to choose the language of the lecture from the DB.

Also, this system further comprising the step for organizing a pool of lectures or a pool of professors for the learners to select lecture or professor for studying.

Referring to FIG. 2 and FIG. 3, the method for authenticating the learner's ID for online EOD (Examination on demand) by authenticating examinee's ID via Internet in a testing system having a test DB 220 of question pool, a plurality of examinee's web terminals and a host-computer 203 for scholastic management, the method is comprising, a step for registering the examinee's Bio-ID (Biometrics Identification) such as a fingerprint, an iris of eye, or a vein of learners, a step for organizing a TEST DB 220 with a question pool of each lecture that having a means for generating an instruction signal on each question or random of questions for instructing to input the examinee's Bio-ID, a step for login to the TEST DB with Bio-ID of the examinee, a step for determining the starting time of examination by the host-computer according to the examinee's Bio-ID inputted from examinee's terminal, a step for authenticating the examinee's Bio-ID gradually during examination, according to instruction signal generated by host-computer of the TEST DB, and a step for authenticating the examinee's Bio-ID for determining the logout time by inputting the examinee's Bio-ID.

Wherein the ID authenticating step during examination, the instruction signal requesting to input the examinee's Bio-ID may be inserted in the contents of each question or randomly selected questions of EOD system.

Wherein the ID authenticating step during examination, while the time for inputting examinee's Bio-ID over, which set programmed on the host-computer, the host-computer controls stopping the progress of the examination and generating a warning signal to the examinee's terminal.

Wherein the step for registering examinee's Bio-ID, a digital camera can be installed at the examinee's PC terminal, and the host-computer observe the examinee's unusual behavior to make more credibility of EOD method.

Referring FIG. 3, this invention also provides method for operating an e-learning system in a cyber schools such as primary school, middle school, high school, college, university or graduate school having a host-computer 301, a DB 302 of the contents of e-learning lecture a TEST DB (Test Database) 303 of question pool and a plurality of learners' PC terminal 351˜35n, the method is comprising, a step of registering the learners' physical Bio-ID (Biometric Identification), such as a fingerprint, an iris of eye, a veins or a etc., to the host-computer by the learners' terminal, a step for composing a DB of e-learning contents for digital video on-demand operation with a means for generating an instruction signal for requesting the learners to input their Bio-ID at login, logout and gradually at least one or more part of the contents, a step of establishing a TEST DB 303 of question pool of each lecture having a means for generating an instruction signal for requesting examinees to input their Bio-ID at login, logout and every question or a random of questions, a step for calculating the accumulation of studying hours of each lecture class according to the Bio-ID signal, a step for granting the qualification for test, when finishing the study by the accumulation of studying hour of each lecture set to the host-computer, a step for requesting the test of attended lecture by accessing the TEST DB 303 with the learner's Bio-ID at the learner's terminal, a step for testing by authenticating the learner's Bio-ID at the starting, the ending and every question or a random of questions, a step for granting credit of each lecture when the host-computer scores and marks the test result over that the standard set on the computer, and a step for granting graduation of course when the learner completes the course of study, by acquiring all of credits set on the curriculum.

Wherein the step for composing the DB, the contents of each lecture can be dubbed by multilingual system for the selection of the language at the learner's terminal. This invention is further comprising the step for organizing a pool of lectures or a pool of professor for the learner's choice to select lectures or professors.

Also, the invention is further comprising the step for organizing a regional test system facility like TOEIC or GRE test system facility for authenticating the examinee's own identity at the regional test system and take an examination at the specific PC terminal 351˜35n of the test system by inputting Bio-ID of the each learner by the EOD system for increasing the credulity of credit.

Wherein the step for qualifying the graduation, further establishing the step for requesting thesis to a test committee of the instruction through online and granting a degree when the learners pass the test of thesis through online or visual conference method at the regional test system facility.

This invention is further comprising the step to establishing a blog or a homepage of each lecture for providing communication means between a professor and a plurality of learners as well as supplement of each lecture such as Q&A or professor's additional explanation and complement.

Referring to FIG. 3, this invention provides the method for dealing a credit through Internet, the method is comprising a step for establishing a network between a host-computer of e-learning service provider and a plurality of PC terminals of learners for authenticating the learners' ID by Bio-ID (Biometric Identification) such as a fingerprint, an iris of eye, a veins or a etc., of each learner, a step for registering the learners' Bio-ID to the host-computer for verifying ID via Internet, a step for composing a DB of lectures for sale in digital video on demand format having a means for generating an instruction signal to the learners to input their Bio-ID at login, logout and gradually at least one or more times during lecture class, a step for establishing a TEST DB of question pool of each lecture for the examination on demand, a step for calculating accumulated learning time of each study according to the signal of the Bio-ID of each learner, a step for granting the qualification for test when the host-computer recognize the learner completed the study of each lecture according to the accumulated learning hour of each lecture, a step for requesting a test of the attended lecture by accessing the TEST DB with learner's Bio-ID, a step for testing by authenticating the learner's Bio-ID at starting, ending and every question or a random of questions, and a step for issuing a certificate of completion of study of the attended lecture by online when the host-computer recognizes the score of the test meets the guideline for the completion of the course.

Wherein the step for composing the DB, the contents of each lecture can be dubbed by multilingual system for the selection of language at the learner's terminal.

This system of the present invention is further comprising the step for dividing profit between the service provider and professors according to the registrant number and tuition fee of each lecture by the calculation of the host-computer.

The invention may be embodied in other specific forms without departing from the spirit or essential characteristic thereof. The present embodiment is therefore to be consisted in all respects as illustrative and not restrictive, the scope of the invention being indicated by the appended claims rather than by the foregoing description and all changes which come within the meaning and range of equivalency of the claims are therefore intended to be embraced therein.

1. A method for online EOD (Examination on demand) by authenticating examinee's ID via Internet in a testing system having a test DB of question pool, a plurality of examinee's web terminals and a host-computer for scholastic management, the method comprising, (a) a step for registering the examinee's Bio-ID (Biometrics Identification) such as a fingerprint, an iris of eye, or a vein of learners, (b) a step for organizing a TEST DB with a question pool of each lecture that having a means for generating an instruction signal on each question or random of questions for instructing to input the examinee's Bio-ID, (c) a step for login to the TEST DB with Bio-ID of the examinee, (d) a step for determining the starting time of examination by the host-computer according to the examinee's Bio-ID inputted from examinee's terminal, (e) a step for authenticating the examinee's Bio-ID gradually during examination, according to instruction signal generated by host-computer of the TEST DB, and (f) a step for authenticating the examinee's Bio-ID for determining the logout time by inputting the examinee's Bio-ID.

2. The method of claim 1, wherein the ID authenticating step during examination, the instruction signal requesting to input the examinee's Bio-ID are inserted in the contents of each question or randomly selected questions of EOD system.

3. The method of claim 1, wherein the ID authenticating step during examination, while the time for inputting examinee's Bio-ID over, which set programmed on the host-computer, the host-computer controls stopping the progress of the examination and generating a warning signal to the examinee's terminal.

4. The method of claim 1, wherein the step for registering examinee's Bio-ID, a digital camera is installed at the examinee's PC terminal, and the host-computer observe the examinee's unusual behavior to make more credibility of EOD method.

5. A method for authenticating learners' ID via Internet in a e-learning system having an e-learning host-computer, a DB of e-learning contents and a plurality of the learner's PC terminal, the method comprising, (a) a step for registering learner's Bio-ID such as a fingerprint, an iris of eye, a veins or etc., to the e-learning host-computer, (b) a step for organizing a DB of contents of e-learning lectures DVOD (Digital Video On Demand) and each e-learning lecture having a means for generating an instruction signal requesting the learners to input their Bio-ID according to the progress of each lecture, (c) a step for authenticating the learner's Bio-ID to determine the login time of the lecture, according to the instruction signal generated by the contents of each lecture, (d) a step for authenticating the learner's Bio-ID by the host-computer according to the instruction signal gradually generated during the progress of each lecture, and (e) a step for authenticating the learner's Bio-ID for determining the logout time of each lecture.

6. The method of claim 5, wherein the ID authenticating step during lecture class, the instruction signal to be generated by the host-computer with its' software programmed, or combining the signal generated by the host-computer and the contents of each lecture.

7. The method of claim 5, further comprising the step for determining the class in and out time of each lecture class by inputting the learner's Bio-ID signal so that the host-computer memorizes class in and out time with contents of each lecture of logout point and calculate the accumulation of learning hours for the partial study.

8. The method of claim 5, wherein the ID authenticating step during lecture class, when the learners fail to input their Bio-ID, the host-computer controls stopping the progress of lecture and generating a warning signal to the learner's terminal.

9. The method of claim 5, wherein the step for organizing the DB, the contents of each lecture dubbed by multilingual system enables the learner's terminal to select the language.

10. The method of claim 5, further comprising the step for organizing a pool of lectures or a pool of professors for the learners to select lecture or professor for studying.

11. A method for operating an e-learning system in a cyber schools such as primary school, middle school, high school, college, university or graduate school having a host-computer, a DB of the contents of e-learning lecture a TEST DB (Test Database) of question pool and a plurality of learners' PC terminal, the method comprising, (a) a step of registering the learners' physical Bio-ID (Biometric Identification), such as a fingerprint, an iris of eye, a veins or etc., to the host-computer by the learners' terminal, (b) a step for composing a DB of e-learning contents for digital video on-demand operation with a means for generating an instruction signal for requesting the learners to input their Bio-ID at login, logout and gradually at least one or more part of the contents, (c) a step of establishing a TEST DB of question pool of each lecture having a means for generating an instruction signal for requesting examinees to input their Bio-ID at login, logout and every question or a random of questions, (d) a step for calculating the accumulation of studying hours of each lecture class according to the Bio-ID signal, (e) a step for granting the qualification for test, when finishing the study by the accumulation of studying hour of each lecture set to the host-computer, (f) a step for requesting the test of attended lecture by accessing the TEST DB with the learner's Bio-ID at the learner's terminal, (g) a step for testing by authenticating the learner's Bio-ID at the starting, the ending and every question or a random of questions, (h) a step for granting credit of each lecture when the host-computer scores and marks the test result over that the standard set on the computer, and (i) a step for granting graduation of course when the learner completes the course of study, by acquiring all of credits set on the curriculum.

12. The method of claim 11, wherein the step for composing the DB, the contents of each lecture may be dubbed by multilingual system for the selection of the language at the learner's terminal.

13. The method of claim 11, further comprising the step for organizing a pool of lectures or a pool of professor for the learner's choice to select lectures or professors.

14. The method of claim 11, further comprising the step for organizing a test regional system like TOEIC or GRE test system for authenticating the examinee's own identity at the regional test system and take an examination with the specific PC terminal at the regional test system by inputting Bio-ID of the each learner to the EOD system for increasing the credulity.

15. The method of claim 11, wherein the step for qualifying the graduation, further establishing the step for requesting thesis for granting a degree when the learners pass the test of thesis through online or visual conference method at the test system.

16. The method of claim 11, further comprising the step to establishing a blog or a homepage of each lecture for providing communication means between a professor and a plurality of learners as well as supplement of each lecture such as Q&A or professor's additional explanation and complement.

17. A method for dealing a credit through Internet, comprising (a) a step for establishing a network between a host-computer of e-learning service provider and a plurality of PC terminals of learners for authenticating the learners' ID by Bio-ID (Biometric Identification) such as a fingerprint, an iris of eye, a veins or etc., of each learner, (b) a step for registering the learners' Bio-ID to the host-computer for verifying ID via Internet, (c) a step for composing a DB of lectures for sale in digital video on demand format having a means for generating an instruction signal to the learners to input their Bio-ID at login, logout and gradually at least one or more times during lecture class, (d) a step for establishing a TEST DB of question pool of each lecture for the examination on demand, (e) a step for calculating accumulated learning time of each study according to the signal of the Bio-ID of each learner, (f) a step for granting the qualification for test when the host-computer recognize the learner completed the study of each lecture according to the accumulated learning hour of each lecture, (g) a step for requesting the test of the attended lecture by accessing the TEST DB with learner's Bio-ID, (h) a step for testing by authenticating the learner's Bio-ID at starting, ending and every question or a random of questions, and (i) a step for issuing a certificate of completion of study of the attended lecture by online when the host-computer recognizes the score of the test meets the guideline for the completion of the course.

18. The method of claim 17, wherein the step for composing the DB, the contents of each lecture may be dubbed by multilingual system for the selection of language at the learner's terminal.

19. The method of claim 17, further comprising the step for dividing profit between the service provider and professors according to the registrant number and tuition fee of each lecture by the calculation of the host-computer.

20. A system for e-learning comprising, (a) a DB(Database) of digital video on demand contents of lectures having a means for generating an instruction signal requesting learners to input their Bio-ID(Biometric Identification) when login, logout and at least one or more parts of the each lecture, (b) a TEST DB of question pool of each lecture for EOD (Examination On-Demand) having a means for generating on instruction signal requesting learners to input their Bio-ID at every question or at random of the questions, (c) a communication means such as a blog or a homepage for communicating between a professor and a plurality of learners, and (d) a host-computer for controlling the system by authenticating the Bio-ID of learners at login, logout and at least one or more during the studying or testing process and calculating the accumulation of the each partial study of the lecture for granting credit.

21. The system of claim 20, wherein the means for generating signal for requesting learners to input their Bio-ID, the means is the host-computer or combining together with the host-computer and the contents of the DB or question of the EOD system
